(19) United States
(12) Patent Application Publication
(10) Pub. No.: US 2020/0317267 A1
(43) Pub. Date: Oct. 8, 2020

(54) PARKING ASSISTANCE DEVICE

(71) Applicant: AISIN SEIKI KABUSHIKI KAISHA, Kariya-shi, Aichi (JP)

(72) Inventors: Tetsuya MARUOKA, Okazaki-shi, Aichi-ken (JP); Kazuya WATANABE, Anjo-shi, Aichi-ken (JP); Kinji YAMAMOTO, Anjo-shi, Aichi-ken (JP); Itsuko FUKUSHIMA, Nagoya-shi, Aichi-ken (JP); Takayuki NAKASHO, Anjo-shi, Aichi-ken (JP)

(73) Assignee: AISIN SEIKI KABUSHIKI KAISHA, Kariya-shi, Aichi (JP)

(21) Appl. No.: 16/754,427

(22) PCT Filed: Oct. 3, 2018
(86) PCT No.: PCT/JP2018/037000

§ 371 Date: Apr. 8, 2020

(30) Foreign Application Priority Data
Oct. 10, 2017 (JP) 2017-197141

(51) Int. Cl. B62D 15/02; B62D 13/06; B60R 1/00

(52) U.S. Cl. CPC B62D 15/0275; B62D 15/028; B62D 13/06; B60R 2300/106; B60R 2300/806; B60R 2300/607; B60R 2300/305; B60R 1/003

(57) ABSTRACT

A parking assistance device according to an embodiment includes: an image processing unit that generates a surrounding image representing a situation around a towing vehicle based on an image capturing result obtained by an image capturing unit provided in the towing vehicle; a path obtaining unit that obtains a guidance path for guiding a towed vehicle to a target parking position, the guidance path extending from the target parking position as a starting point in a case where the target parking position of the towed vehicle connected to the towing vehicle is set; and a display processing unit that displays the guidance path such that the guidance path is superimposed on the surrounding image when the guidance path is obtained.

### TECHNICAL FIELD

An embodiment of the present invention relates to a parking assistance device.

### BACKGROUND ART

Conventionally, a technology for assisting in an operation of parking a towed vehicle connected to a towing vehicle at a predetermined target parking position starting from a rear end of the towed vehicle has been proposed. As an example of such a technology, a technology, in which a virtual path line extending from the rear end of the towed vehicle to the target parking position (parking target region) is calculated, and the virtual path line is displayed so as to be superimposed on a surrounding image representing a situation around the towing vehicle and the towed vehicle, to thereby visually notify a driver of information serving as a guide for moving the towed vehicle by the towing vehicle, has been known.

### CITATION LIST

### Patent Literature

Patent Document 1: US 2014/0,160,276 A

### SUMMARY OF INVENTION

### Problem to be Solved by the Invention

However, in general, accuracy of a virtual path line calculated from a certain point as a starting point tends to decrease as a distance from the starting point increases. Therefore, in the technology according to the related art as described above, even in a case where the towing vehicle is driven so that the towed vehicle moves along the path line superimposed on the surrounding image, it may not be possible to accurately guide the towed vehicle to the target parking position located away from the rear end of the towed vehicle that is the starting point of the path line.

Therefore, one of the objects of the embodiment is to provide a parking assistance device capable of providing a guide for more accurately guiding a towed vehicle to a target parking position.

### Means for Solving Problem

A parking assistance device according to an embodiment includes an image processing unit that generates a surrounding image representing a situation around a towing vehicle based on an image capturing result obtained by an image capturing unit provided in the towing vehicle; a path obtaining unit that obtains a guidance path for guiding a towed vehicle to a target parking position, the guidance path extending from the target parking position as a starting point, when the target parking position of the towed vehicle connected to the towing vehicle is set; and a display processing unit that displays the guidance path such that the guidance path is superimposed on the surrounding image when the guidance path is obtained. With this configuration, the guidance path superimposed on the surrounding image becomes a more accurate guide particularly in the vicinity of the target parking position, as compared with, for example, the path line extending from a rear end of the towed vehicle as a starting point according to the related art, and thus it is possible to provide a guide for more accurately guiding the towed vehicle to the target parking position.

In the above parking assistance device, the target parking position may include a pair of target positions corresponding to a vehicle width of the towed vehicle, and the display processing unit may display the guidance path extending from at least one target position located inside of a turn of the towing vehicle among the pair of target positions such that the guidance path is superimposed on the surrounding image. With this configuration, it is possible to avoid the towing vehicle and the towed vehicle from turning excessively by driving the towing vehicle while checking the guidance path.

In the above parking assistance device, when the towed vehicle approaches the target parking position, the display processing unit may delete the guidance path superimposed on the surrounding image. With this configuration, it is possible to easily recognize that the towed vehicle approaches the target parking position by confirming the deletion of the guidance path.

In the above parking assistance device, the display processing unit may change a display mode of the guidance path according to a positional relationship between the towed vehicle and the target parking position. With this configuration, it is possible to easily recognize the progress of parking of the towed vehicle to the target parking position by observing a change in the display mode of the guidance path.

In the above parking assistance device, the display processing unit may change a display mode of the guidance path according to brightness of the surrounding image. With this configuration, it is possible to improve visibility of the guidance path by displaying the guidance path brightly in a situation where the surrounding image is dark, such as at night.

In the above parking assistance device, the display processing unit may further superimpose a first indicator for highlighting the target parking position on the surrounding image in addition to the guidance path. With this configuration, it is possible to improve identifiability of the target parking position.

In the above parking assistance device, the display processing unit further superimposes, on the surrounding image, a second indicator representing movement of the towed vehicle expected when the towed vehicle reaches the target parking position along the guidance path. With this configuration, it is possible to easily obtain an image of the movement of the towed vehicle until the towed vehicle reaches the target parking position.

In the above parking assistance device, when the towing vehicle is in a backward movement state, the path obtaining unit may newly obtain the guidance path each time the towing vehicle is stopped, and the display processing unit may update the guidance path superimposed on the surrounding image each time the guidance path is newly obtained. With this configuration, for example, when the towed vehicle is moved to a position deviating from the currently displayed guidance path, an appropriate guidance path corresponding to the change in the situation can be obtained.

In the above parking assistance device, the surrounding image may include an overhead image representing the situation around the towing vehicle viewed from above, and an inside image representing a situation inside of a turn of the towing vehicle, and the display processing unit may display at least one image of the overhead image and the inside image as the surrounding image, and superimposes the guidance path on the at least one image. With this configuration, it is possible to easily check the guidance path on the basis of at least one of the overhead image or the inside image suitable for grasping the situation at the time of backward movement and turning of the towing vehicle.

### BRIEF DESCRIPTION OF DRAWINGS

FIG. 1 is an exemplary schematic side view illustrating an example of a state where a towing vehicle and a towed vehicle according to an embodiment are connected;

FIG. 2 is an exemplary schematic top view illustrating an example of a state where the towing vehicle and the towed vehicle according to the embodiment are connected;

FIG. 3 is an exemplary schematic view illustrating an example of a compartment of the towing vehicle according to the embodiment;

FIG. 4 is an exemplary schematic block diagram illustrating a hardware configuration of a parking assistance system according to the embodiment;

FIG. 5 is an exemplary schematic block diagram illustrating functions of a parking assistance device implemented in an electronic control unit (ECU) of the parking assistance system according to the embodiment;

FIG. 6 is an exemplary schematic view illustrating an example of a screen displayed on a display device when a target parking position is set in the embodiment;

FIG. 7 is an exemplary schematic view illustrating an example of a screen displayed on the display device when the towing vehicle moves forward after setting of the target parking position using an image illustrated in FIG. 6 is completed, in the embodiment;

FIG. 8 is an exemplary schematic view illustrating an example of a screen displayed on the display device when a traveling direction of the towing vehicle is switched to a backward direction after the forward movement as illustrated in FIG. 7 is completed, in the embodiment;

FIG. 9 is an exemplary schematic view illustrating an example of a screen displayed on the display device when the towing vehicle moves further backward as compared with a situation illustrated in FIG. 8, in the embodiment;

FIG. 10 is an exemplary schematic view illustrating an example of a screen displayed on the display device when the towing vehicle moves further backward as compared with a situation illustrated in FIG. 9 and the towed vehicle approaches the target parking position, in the embodiment;

FIG. 11 is an exemplary schematic view illustrating an example of a screen displayed on the display device when an operation of switching to a surrounding image of another viewpoint is performed in the screen illustrated in FIG. 8, in the embodiment;

FIG. 12 is an exemplary schematic view illustrating an example of a screen displayed on the display device when an operation of switching to a surrounding image of another viewpoint is performed in the screen illustrated in FIG. 9, in the embodiment.

FIG. 13 is an exemplary schematic view illustrating an example of a screen displayed on the display device when an operation of switching to a surrounding image of another viewpoint is performed in the screen illustrated in FIG. 10, in the embodiment;

FIG. 14 is an exemplary schematic flowchart illustrating processing performed as parking assistance by the parking assistance device according to the embodiment;

FIG. 15 is an exemplary schematic flowchart illustrating processing performed by the parking assistance device during display of a guidance path according to the embodiment;

FIG. 16 is an exemplary schematic flowchart illustrating processing performed by the parking assistance device according to the embodiment in a case of changing a display mode of the guidance path according to a positional relationship between the towed vehicle and the target parking position;

FIG. 17 is an exemplary schematic flowchart illustrating processing performed by the parking assistance device according to the embodiment in a case of changing the display mode of the guidance path according to a brightness of a surrounding image;

FIG. 18 is an exemplary schematic view illustrating an example of an indicator (icon or symbol) for highlighting a target parking position, which can be displayed in a modified example; and

FIG. 19 is an exemplary schematic view illustrating an example of a ghost of a towed vehicle, which can be displayed in another modified example.

### DESCRIPTION OF EMBODIMENTS

### Embodiment

Hereinafter, an embodiment will be described with reference to the drawings. A configuration of the embodiment described below, and an action and a result (effect) provided by the configuration are merely examples, and are not limited to the following description.

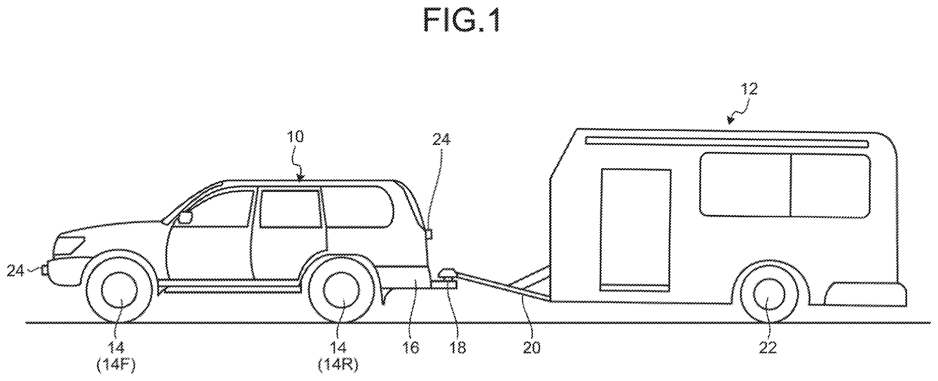

First, various structures provided on a towing vehicle and a towed vehicle (trailer) towed by the towing vehicle to which a technology of the embodiment is applied will be schematically described with reference to FIGS. 1 to 3.

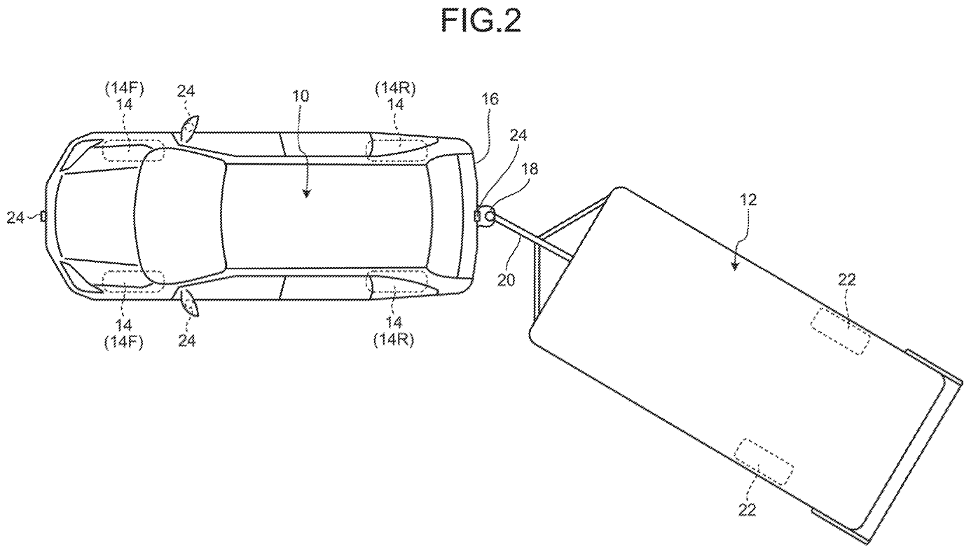

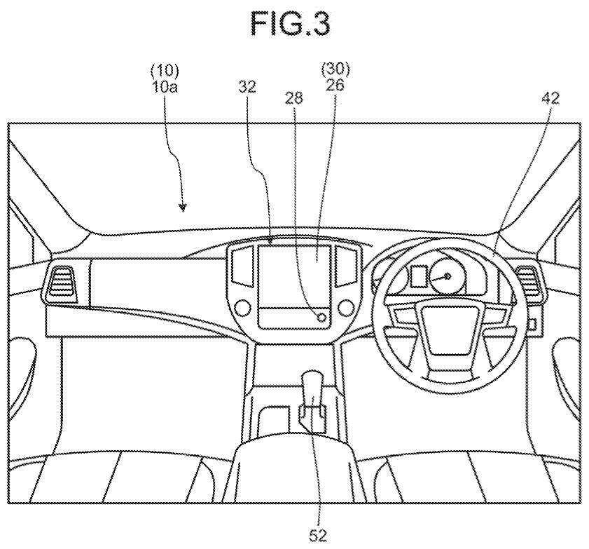

FIG. 1 is an exemplary schematic side view illustrating an example of a state where a towing vehicle 10 and a towed vehicle 12 according to the embodiment are connected, FIG. 2 is an exemplary schematic top view illustrating an example of a state where the towing vehicle 10 and the towed vehicle 12 according to the embodiment are connected, and FIG. 3 is an exemplary schematic view illustrating an example of a compartment 10a of the towing vehicle 10 according to the embodiment.

As illustrated in FIGS. 1 and 2, the towing vehicle 10 according to the embodiment is a four-wheeled vehicle including a pair of left and right front wheels 14F and a pair of left and right rear wheels 14R. Hereinafter, the front wheels 14F and the rear wheels 14R may be collectively referred to as wheels 14 for simplification. In the embodiment, sideslip angles of some or all of the four wheels 14 are adjusted according to an operation of a steering wheel 42 (see FIG. 3) by a driver.

Note that the towing vehicle 10 according to the embodiment may be an automobile using an internal combustion engine (engine, not illustrated) as a driving source, an automobile using an electric motor (motor, not illustrated) as a driving source, or an automobile using both of the internal combustion engine and the electric motor as driving sources. Further, the towing vehicle 10 may be a sport utility vehicle (SUV) (multipurpose vehicle for sports), a so-called pickup truck having a cargo bed provided at a rear portion thereof, or a general passenger vehicle.

Further, various transmissions can be mounted on the towing vehicle 10 according to the embodiment, and various devices (systems, components, and the like) required for driving the internal combustion engine or the electric motor can be mounted on the towing vehicle 10 according to the embodiment. In addition, the type, number, layout, and the like of the devices related to the driving of the wheels 14 in the towing vehicle 10 can be variously set (changed).

As illustrated in FIGS. 1 and 2, a towing device (hitch) 18 is provided on a rear bumper 16 of the towing vehicle 10 according to the embodiment, the towing device 18 projecting from, for example, a lower portion of a central portion of the rear bumper 16 in a vehicle width direction. The towing device 18 includes, for example, a hitch ball having a spherical distal end portion and standing in a vertical direction (a top-bottom direction of the vehicle) and the hitch ball is covered with a coupler provided at a distal end of a connecting member 20 fixed to a front end of the towed vehicle 12. With this configuration, the towing vehicle 10 and the towed vehicle 12 are connected to each other in a state where the towed vehicle 12 can swing (turn) in the vehicle width direction with respect to the towing vehicle 10. Therefore, in this configuration, the hitch ball of the towing device 18 transfers forward, backward, leftward, and rightward movements to the towed vehicle 12 via the connecting member 20, and receives power of acceleration or deceleration.

Further, as illustrated in FIGS. 1 and 2, the towed vehicle 12 according to the embodiment includes a pair of wheels 22. Hereinafter, an example in which the wheels 22 are driven wheels will be described. In other words, hereinafter, an example in which the towed vehicle 12 is configured as a driven vehicle that does not include a driving wheel or a steering wheel will be described. Note that, in the example illustrated in FIGS. 1 and 2, the towed vehicle 12 is configured as a box type vehicle including at least one of a boarding space, a living section, a storage space, or the like, but in the embodiment, the towed vehicle 12 may also be configured as a cargo-bed type vehicle on which a cargo (a container, a boat, or the like) is loaded.

As illustrated in FIGS. 1 and 2, an image capturing unit 24 is provided at each of a front end, a rear end, and left and right side mirrors of the towing vehicle 10. The image capturing unit 24 is, for example, a digital camera including a built-in image capturing element such as a charge coupled device (CCD) image sensor or a complementary metal oxide semiconductor (CMOS) image sensor. The image capturing unit 24 captures an image of a surrounding area of the towing vehicle 10 at a predetermined frame rate, and outputs a captured image (image data) obtained by the image capturing. The captured image can constitute a moving image, as a frame image.

The image capturing unit 24 provided at the rear end of the towing vehicle 10 captures an image of a region including the connecting member 20 and at least a front end portion of the towed vehicle 12, thereby outputting a captured image for detecting a connection posture (whether or not the connection is made, a connection angle, and the like) of the towing vehicle 10 and the towed vehicle 12. Further, the image capturing unit 24 provided at the front end of the towing vehicle 10 captures an image of a region in front of the towing vehicle 10, thereby outputting a captured image for recognizing a situation in front of the towing vehicle 10. Moreover, the image capturing units 24 provided at the left and right side mirrors of the towing vehicle 10 each capture an image of a region at a side of the towing vehicle 10, thereby outputting a captured image for recognizing a situation at the side of the towing vehicle 10.

In the embodiment, for example, an image with a wider viewing angle than that of a captured image obtained by only one image capturing unit 24, an overhead image representing a situation around the towing vehicle 10 viewed from above, or the like can be generated as a surrounding image representing a situation around the vehicle by performing various types of image processing including viewpoint change, composition, or the like, on the captured images obtained by the plurality (four) of image capturing units 24 as described above.

As illustrated in FIG. 3, a monitor device 32 including a display device (display) 26 capable of outputting various images and a sound output device (speaker) 28 capable of outputting various sounds is provided in the compartment 10a of the towing vehicle 10. The monitor device 32 is provided at the center of a dashboard in the compartment 10a in the vehicle width direction (left-right direction). The display device 26 is implemented by a liquid crystal display (LCD), an organic electroluminescent display (OELD), or the like.

A touch panel 30 is provided in a region where an image is displayed on the display device 26, that is, a display screen, the touch panel 30 being capable of detecting coordinates of a position to which a pointer such as a finger or a stylus approaches (or contacts) in the display screen. Therefore, a user (for example, the driver) can visually recognize an image displayed on the display screen of the display device 26, and perform an operation (for example, a touch operation) using the pointer such as a finger or a stylus on the touch panel 30 to thereby input various operations.

Note that, in the embodiment, the monitor device 32 may include various physical operation input units such as a switch, a dial, a joystick, and a push button. Further, in the embodiment, another sound output device may be provided at a position different from a position of the monitor device 32 in the compartment 10a. In this case, various types of sound information can be output from both of the sound output device 28 and another sound output device. Further, in the embodiment, the monitor device 32 may be configured to be able to display information on various systems such as a navigation system and an audio system.

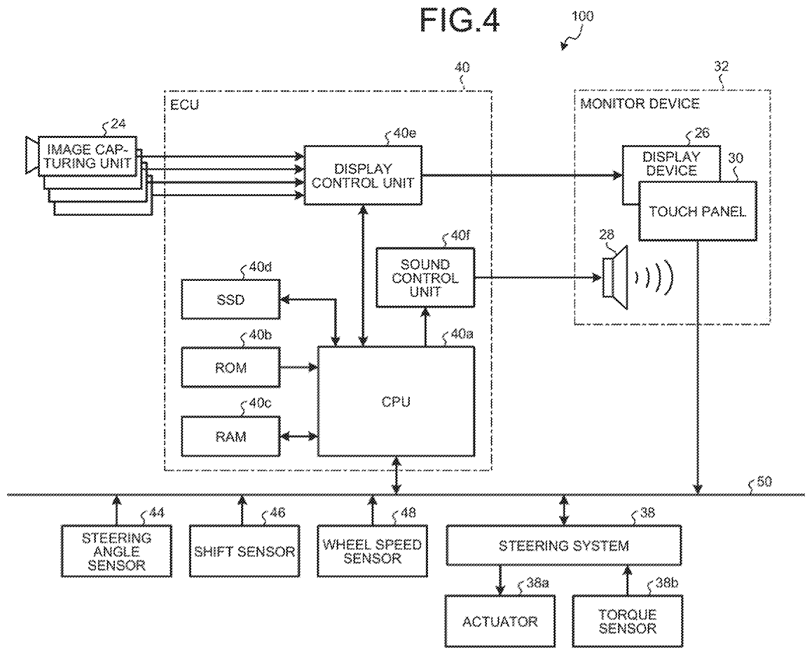

Here, the towing vehicle 10 according to the embodiment includes a parking assistance system 100 having a function of assisting an operation of parking the towed vehicle 12 connected to the towing vehicle 10 at a predetermined target parking position starting from a rear end of the towed vehicle 12. Note that the parking assistance system 100 can also have a function of assisting in parking of the towing vehicle 10 in a state where the towed vehicle 12 is not connected. Hereinafter, various types of hardware constituting the parking assistance system 100 according to the embodiment will be schematically described with reference to FIG. 4.

FIG. 4 is an exemplary schematic block diagram illustrating a hardware configuration of the parking assistance system 100 according to the embodiment. Note that configurations, arrangement, electrical connection, and the like of various types of hardware to be described below are merely examples, and can be variously set (changed).

As illustrated in FIG. 4, the parking assistance system 100 according to the embodiment includes an image capturing unit 24, a monitor device 32, a steering system 38, an electronic control unit (ECU) 40, a steering angle sensor 44, a shift sensor 46, and a wheel speed sensor 48.

The monitor device 32, the steering system 38, the ECU 40, the steering angle sensor 44, the shift sensor 46, and the wheel speed sensor 48 are communicably connected to one another via an in-vehicle network 50 that is an electric communication line. Note that the in-vehicle network 50 is implemented by, for example, a controller area network (CAN).

The steering system 38 includes an electric power steering system, a steer-by-wire (SBW) system, or the like. The steering system 38 is connected to an actuator 38a and a torque sensor 38b. The steering system 38 turns a part or all of the four wheels 14 by operating the actuator 38a under the control of the ECU 40 or the like. The torque sensor 38b detects torque generated in response to an operation of the steering wheel 42 (see FIG. 3) performed by the driver, and transmits a detection result to the ECU 40.

The steering angle sensor 44 is a sensor that detects an amount of operation of the steering wheel 42 (see FIG. 3) performed by the driver. For example, the steering angle sensor 44 is implemented by a Hall element, detects a rotation angle of a rotating portion of the steering wheel 42 as a steering amount, and transmits a detection result to the ECU 40.

The shift sensor 46 detects a position of a lever, an arm, a button, or the like as a movable portion included in a shift operation unit 52 (see FIG. 3) provided near a driver's seat in the compartment 10a of the towing vehicle 10, and transmits a detection result to the ECU 40.

The wheel speed sensor 48 detects a rotation amount of the wheel 14, the number of rotations of the wheel 14 per unit time, and the like, and transmits a detection result to the ECU 40. The detection result obtained by the wheel speed sensor 48 can be used to estimate a vehicle speed or a position of the towing vehicle 10 (and the towed vehicle 12).

The ECU 40 is a controller that performs an overall control of the parking assistance system 100. The ECU 40 includes computer resources such as a central processing unit (CPU) 40a, a read only memory (ROM) 40b, a random access memory (RAM) 40c, a solid state drive (SSD) 40d, a display control unit 40e, and a sound control unit 40f.

The CPU 40a is a control unit that controls various types of processing performed by the ECU 40. The CPU 40a reads a program stored in a storage device such as the ROM 40b or the SSD 40d, and is operated according to an instruction included in the program to thereby perform various types of processing. The RAM 40c is used, for example, as a work area when the CPU 40a executes various types of processing.

The display control unit 40e controls image output via the display device 26. Further, the sound control unit 40f controls sound output via the sound output device 28.

Note that, in the embodiment, the CPU 40a, the ROM 40b, and the RAM 40c may be mounted on one integrated circuit. Further, in the embodiment, instead of the CPU 40a, a processor such as a digital signal processor (DSP) or a logic circuit may be provided as a control unit that controls various types of processing performed by the ECU 40.

With the above-described configuration, the ECU 40 according to the embodiment controls each component of the parking assistance system 100 by transmitting a control signal to each component of the parking assistance system 100 via the in-vehicle network 50. At this time, the ECU 40 can use image data obtained from the image capturing unit 24, the detection results obtained from various sensors via the in-vehicle network 50, and the like for control. The various sensors include the torque sensor 38b, the steering angle sensor 44, the shift sensor 46, the wheel speed sensor 48, and the like described above. In addition, the ECU 40 can also use information on the input operation using the touch panel 30 for control, the information being obtained via the in-vehicle network 50.

Here, as described above, the parking assistance system 100 according to the embodiment has a function of assisting in an operation of parking the towed vehicle 12 connected to the towing vehicle 10 at a predetermined target parking position starting from a rear end of the towed vehicle 12. Therefore, the ECU 40, which is a controller that performs an overall control of the parking assistance system 100, is configured to be able to perform a control of displaying, for example, a guide for parking the towed vehicle 12 at a target parking position (target parking region) set by the driver on the display device 26, for parking assistance.

Conventionally, as an example of such a technology of visually notifying a driver of a guide, a technology, in which a virtual path line extending from the rear end of the towed vehicle as a starting point to the target parking position (target parking region) is calculated, and the virtual path line is displayed so as to be superimposed on a surrounding image representing a situation around the towing vehicle and the towed vehicle, has been known.

However, in general, accuracy of a virtual path line extending from a certain point as a starting point tends to decrease as a distance from the starting point increases. Therefore, in the technology according to the related art as described above, even in a case where the towing vehicle is driven so that the towed vehicle moves along the path line superimposed on the surrounding image, it may not be possible to make the rear end of the towed vehicle accurately reach the target parking position located away from the rear end of the towed vehicle that is the starting point of the path line.

Therefore, in the embodiment, a parking assistance device 500, which is a group of functional modules implemented in the ECU 40 for executing the parking assist control, is configured as follows to provide a guide for accurately guiding the rear end of the towed vehicle 12 to the target parking position.

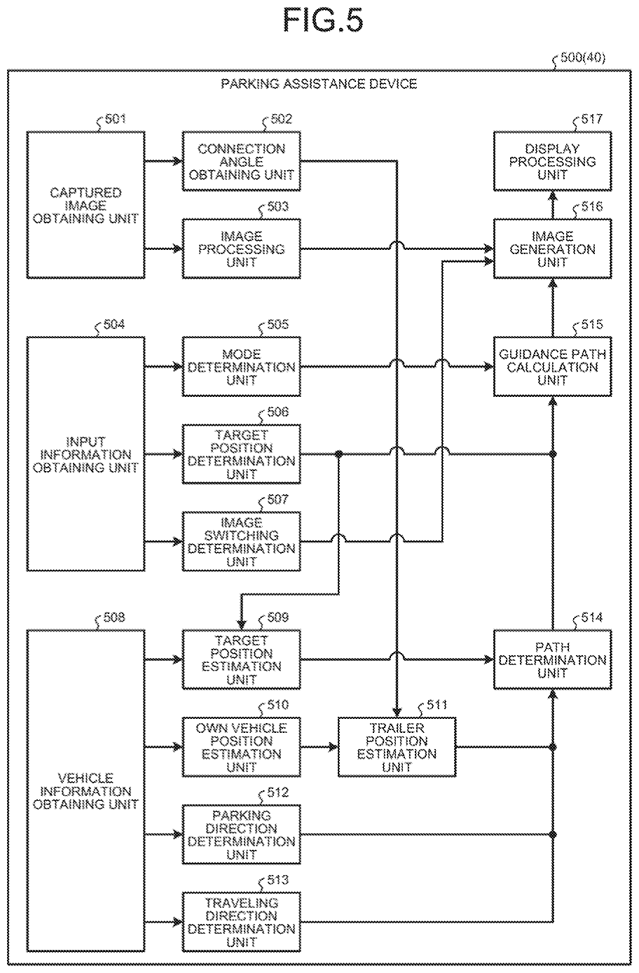

FIG. 5 is an exemplary schematic block diagram illustrating functions of the parking assistance device 500 implemented in the ECU 40 of the parking assistance system 100 according to the embodiment. The parking assistance device 500 is a group of functional modules implemented in the ECU 40 as a result of executing, by the CPU 40a of the ECU 40, software (control program) stored in the ROM 40b, the SSD 40d, or the like. Note that, in the embodiment, some or all of the functional modules in the group illustrated in FIG. 5 may be implemented by dedicated hardware (circuit).

As illustrated in FIG. 5, the parking assistance device 500 according to the embodiment includes a captured image obtaining unit 501, a connection angle obtaining unit 502, and an image processing unit 503.

The captured image obtaining unit 501 obtains a captured image (image data) captured by the image capturing unit 24. As described above, in the embodiment, the captured image obtaining unit 501 can obtain four types of captured images including a captured image of the region in front of the towing vehicle 10, a captured image of a region behind the towing vehicle 10, and captured images of the regions on the right and left sides of the towing vehicle 10.

The connection angle obtaining unit 502 performs image recognition processing on the captured image obtained by the captured image obtaining unit 501 to calculate (obtain) an angle of the towed vehicle 12 with respect to the direction of the towing vehicle 10, that is, a current connection angle between the towing vehicle 10 and the towed vehicle 12.

The image processing unit 503 performs various types of image processing including viewpoint change, composition, and the like on the captured image obtained by the captured image obtaining unit 501, and generates a surrounding image representing a situation around the towing vehicle 10.

Further, as illustrated in FIG. 5, the parking assistance device 500 according to the embodiment includes an input information obtaining unit 504, a mode determination unit 505, a target position determination unit 506, and an image switching determination unit 507.

The input information obtaining unit 504 receives various types of input information input by the driver. Examples of the input information include information on an operation input by the driver via the touch panel 30 or the like.

The mode determination unit 505 determines whether or not a mode (parking assistance mode) for providing parking assistance to the driver is selected on the basis of the input information received by the input information obtaining unit 504. In the embodiment, when the towed vehicle 12 is towed by the towing vehicle 10, the driver can perform an operation of selecting a parking assistance mode via the touch panel 30 or the like to be provided with a guide for parking, by the towing vehicle 10, the towed vehicle 12 at a desired target parking position, such as displaying a guidance path as described later on the display device 26 together with the surrounding image.

In a case where the driver performs an operation of setting the target parking position of the towed vehicle 12 via the touch panel 30 or the like during execution of the parking assistance mode, the target position determination unit 506 determines the target parking position set by the driver on the basis of input information received by the input information obtaining unit 504 in response to the operation. Note that the operation of setting the target parking position will be described more specifically while exemplifying a screen later, and thus further description will be omitted here.

The image switching determination unit 507 determines, on the basis of the input information received by the input information obtaining unit 504, whether or not to switch the type (viewpoint) of the surrounding image displayed on the display device 26 at the time of performing the parking assistance. Note that the switching of the type of the surrounding image will also be described more specifically while exemplifying a screen later, and thus further description will be omitted here.

Further, as illustrated in FIG. 5, the parking assistance device 500 according to the embodiment includes a vehicle information obtaining unit 508, a target position estimation unit 509, an own vehicle position estimation unit 510, a trailer position estimation unit 511, a parking direction determination unit 512, and a traveling direction determination unit 513.

The vehicle information obtaining unit 508 obtains, as vehicle information, information on specifications of the towing vehicle 10 and the towed vehicle 12 stored in the SSD 40d and the like, detection results obtained by various types of sensors such as the torque sensor 38b, the steering angle sensor 44, the shift sensor 46, and the wheel speed sensor 48, or the like.

The target position estimation unit 509 calculates a positional relationship between the towed vehicle 12 and the target parking position on the basis of the target parking position determined by the target position determination unit 506 and the vehicle information obtained by the vehicle information obtaining unit 508 to estimate an actual position (coordinates) of the target parking position to be reached by the towed vehicle 12.

The own vehicle position estimation unit 510 estimates a current position of the towing vehicle 10 on the basis of the vehicle information obtained by the vehicle information obtaining unit 508.

The trailer position estimation unit 511 estimates a current position of the towed vehicle 12 on the basis of the connection angle obtained by the connection angle obtaining unit 502 and the vehicle information obtained by the vehicle information obtaining unit 508.

The parking direction determination unit 512 determines a turning direction of the towing vehicle 10 that is moving backward and turning for parking of the towed vehicle 12, on the basis of the vehicle information obtained by the vehicle information obtaining unit 508, and determines the turning direction as the parking direction.

The traveling direction determination unit 513 determines a current traveling direction of the towing vehicle 10 on the basis of the vehicle information obtained by the vehicle information obtaining unit 508. For example, in a case where a shift range is set to a range corresponding to a forward gear on the basis of the detection result obtained by the shift sensor 46, the detection result being one of the vehicle information, the traveling direction determination unit 513 determines that the traveling direction is a forward direction, and in a case where the shift range is set to a range (reverse range) corresponding to a reverse gear, the traveling direction determination unit 513 determines that the traveling direction is a backward direction.

Moreover, as illustrated in FIG. 5, the parking assistance device 500 according to the embodiment includes a path determination unit 514, a guidance path calculation unit 515, an image generation unit 516, and a display processing unit 517.

The path determination unit 514 determines, on the basis of the estimation result obtained by the target position estimation unit 509 and the trailer position estimation unit 511 and the determination result obtained by the parking direction determination unit 512 and the traveling direction determination unit 513, whether or not a guidance path for guiding the rear end of the towed vehicle 12 to the target parking position can be configured, the guidance path extending from the target parking position as a starting point.

More specifically, the path determination unit 514 determines whether or not a position of an end portion of a virtual arc extending from the target parking position matches the rear end of the towed vehicle 12, the virtual arc being formed by calculating a minimum turning radius of the towing vehicle 10 and the towed vehicle 12 corresponding to the current connection angle between the towing vehicle 10 and the towed vehicle 12 and enlarging the minimum turning radius by a predetermined ratio, and the end portion of the virtual arc being opposite to an end portion positioned at the target parking position. Further, the path determination unit 514 determines that the guidance path can be configured when the position of the end portion of the virtual arc matches the rear end of the towed vehicle, and determines that the guidance path cannot be configured when the position of the end portion of the virtual arc does not match the rear end of the towed vehicle.

The guidance path calculation unit 515 calculates (obtains) a guidance path based on the target parking position set during execution of the parking assistance mode on the basis of the determination results obtained by the mode determination unit 505, the target position determination unit 506, and the path determination unit 514. The guidance path calculation unit 515 can also be referred to as a path obtaining unit. The calculation of the guidance path by the guidance path calculation unit 515 is performed only in a case where the mode determination unit 505 determines that the guidance path can be configured.

The image generation unit 516 generates an image to be displayed on the display device 26 on the basis of a result of the processing performed by the image processing unit 503, a determination result obtained by the image switching determination unit 507, and a calculation result obtained by the guidance path calculation unit 515. More specifically, in a case where the path determination unit 514 determines that the guidance path can be configured, the image generation unit 516 generates, as the image to be displayed on the display device 26, an image in which the guidance path calculated by the guidance path calculation unit 515 is superimposed on the surrounding image generated by the image processing unit 503 according to the determination result obtained by the image switching determination unit 507.

The display processing unit 517 displays the image generated by the image generation unit 516 on the display device 26. Thus, according to the embodiment, it is possible to provide, as a visual guide for making the towed vehicle 12 to reach the target parking position, a surrounding image on which a guidance path extending from the target parking position as a starting point is superimposed. Since the guidance path in the embodiment starts from the target parking position, it can be said that the guidance path is a more accurate guide especially in the vicinity of the target parking position as compared with, for example, a path line extending from the rear end of the towed vehicle 12 as a starting point according to the related art. Therefore, according to the embodiment, it is possible to provide a guide for more accurately guiding the rear end of the towed vehicle 12 to the target parking position.

With the above-described configuration, the parking assistance device 500 according to the embodiment changes a screen as follows according to a change in situation, the screen being displayed on the display device 26 of the towing vehicle 10 in a case where the driving of the towing vehicle 10 is performed to park the towed vehicle 12.

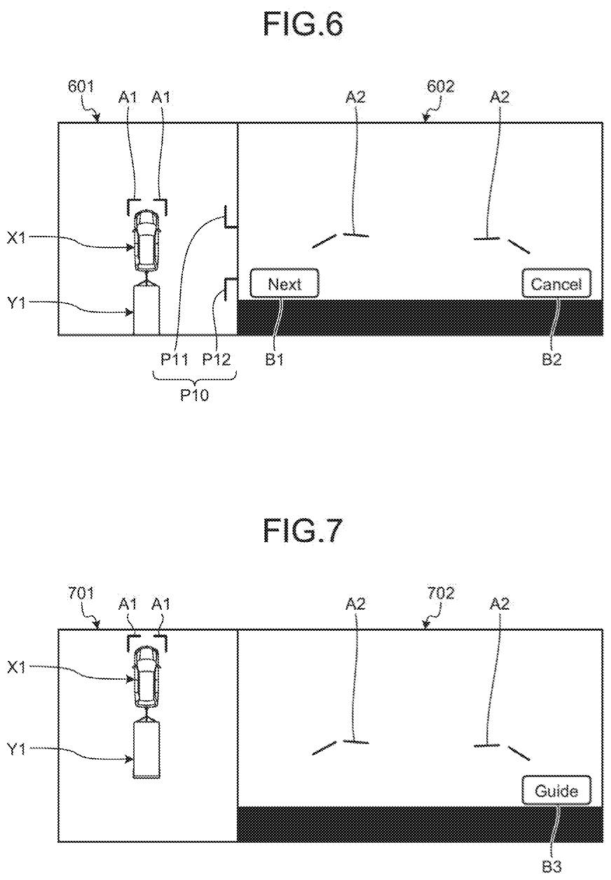

First, in a case where the parking assistance mode is selected by the driver, the parking assistance device 500 causes a screen as illustrated in FIG. 6 below to be displayed on the display device 26, in order for the driver to set the target parking position of the towed vehicle 12.

FIG. 6 is an exemplary schematic view illustrating an example of a screen displayed on the display device 26 when the target parking position is set in the embodiment. In a situation where the screen illustrated in FIG. 6 is displayed, the towing vehicle 10 moves forward (or is stopped).

In the example illustrated in FIG. 6, as the surrounding image, an overhead image 601 representing a situation around the towing vehicle 10 viewed from above, and a front image 602 representing a situation in front of the towing vehicle 10 in a traveling direction of the towing vehicle 10 are displayed side by side. Note that, in the overhead image 601, an indicator (icon or symbol) X1 indicates the towing vehicle 10, an indicator Y1 represents the towed vehicle 12 connected to the towing vehicle 10, and an indicator A1 represents a guide of a course (and a vehicle width) in front of the towing vehicle 10. Further, in the front image 602, an indicator A2 represents the indicator A1 in the overhead image 601 from the viewpoint of the front image 602.

Here, in the example illustrated in FIG. 6, an indicator P10 indicating a candidate for the target parking position of the towed vehicle 12 is displayed in the overhead image 601. The indicator P10 includes a pair of indicators P11 and P12 displayed at an interval corresponding to a vehicle width of the towed vehicle 12. The pair of indicators P11 and P12 corresponds to the vehicle width of the towed vehicle 12. The driver can operate the touch panel 30 or the like to select (touch) the indicator P10 in the overhead image 601 to select the target parking position of the towed vehicle 12, and then can select (touch) a button B1 displayed as a graphical user interface (GUI) in the front image 602 to confirm the selected target parking position. Note that a button B2 displayed as a GUI in the front image 602 is a button for canceling selection of the target parking position and the like.

As can be seen from a positional relationship between the towed vehicle 12 and the target parking position shown in the overhead image 601 of FIG. 6, the towing vehicle 10 needs to move further forward in order to make the towed vehicle 12 reach the target parking position starting from the rear end of the towed vehicle 12. Therefore, when the setting of the target parking position using the image illustrated in FIG. 6 is completed, the driver moves the towing vehicle 10 further forward. Then, the parking assistance device 500 changes the screen displayed on the display device 26 to a screen as illustrated in FIG. 7 below.

FIG. 7 is an exemplary schematic view illustrating an example of a screen displayed on the display device 26 when the towing vehicle 10 moves forward after setting of the target parking position using an image illustrated in FIG. 6 is completed, in the embodiment.

Also in the example illustrated in FIG. 7, similarly to the example illustrated in FIG. 6, as the surrounding image, an overhead image 701 representing a situation around the towing vehicle 10 viewed from above, and a front image 702 representing a situation in front of the towing vehicle 10 are displayed side by side. Note that, in the example illustrated in FIG. 7, as the towing vehicle 10 moves further forward as compared with the situation where the screen illustrated in FIG. 6 is displayed, the indicator P10 representing the target parking position is not displayed in the overhead image 701.

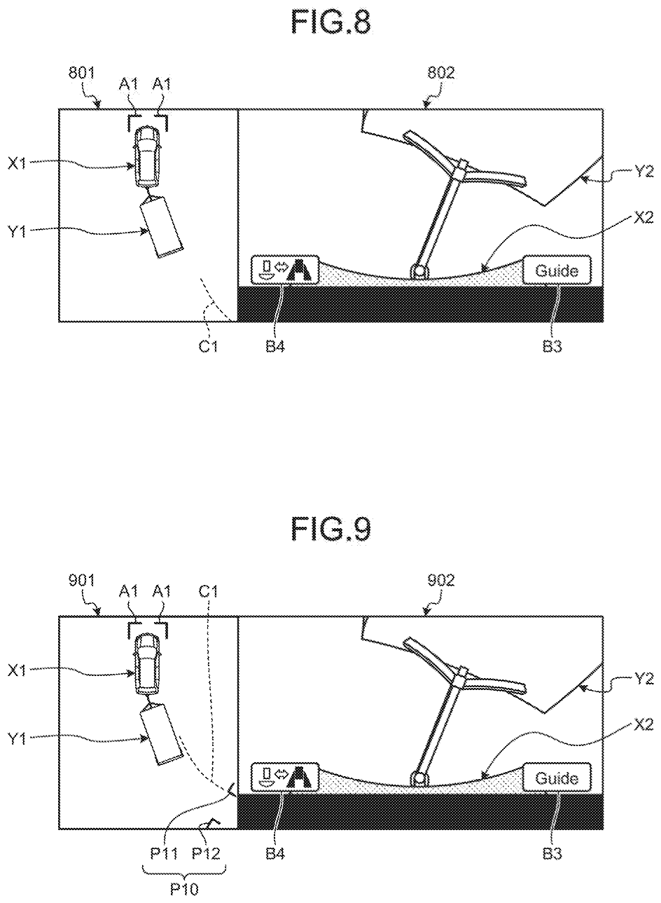

Once the towing vehicle 10 moves forward sufficiently, the driver temporarily stops the towing vehicle 10 and performs an operation of switching the shift range of the towing vehicle 10 to the reverse range in order to make the towed vehicle 12 reach the target parking position starting from the rear end of the towed vehicle 12. Then, the driver selects (touches) a button B3 displayed as a GUI in the front image 702 to be provided with the guidance path as a guide for making the rear end of the towed vehicle 12 reach the target parking position. Then, the parking assistance device 500 changes the screen displayed on the display device 26 to a screen as illustrated in FIG. 8 below.

FIG. 8 is an exemplary schematic view illustrating an example of a screen displayed on the display device 26 when a traveling direction of the towing vehicle 10 is switched to a backward direction after the forward movement as illustrated in FIG. 7 is completed, in the embodiment.

In the example illustrated in FIG. 8, as the surrounding image, an overhead image 801 representing a situation around the towing vehicle 10 viewed from above, and a rear image 802 representing a situation behind the towing vehicle 10 in the traveling direction of the towing vehicle 10 are displayed side by side. Note that, in the rear image 802, an indicator X2 represents the towing vehicle 10 viewed from the viewpoint of the rear image 802, and an indicator Y2 represents the towed vehicle 12 viewed from the viewpoint of the rear image 802.

Here, in the example illustrated in FIG. 8, an indicator C1 representing a guidance path as a guide for making the rear end of the towed vehicle 12 reach the target parking position is superimposed on the overhead image 801. Note that, in the example illustrated in FIG. 8, the indicator P10 indicating the target parking position is not displayed in the overhead image 801 due to the size of the overhead image 801, but the guidance path represented by the indicator C1 extends, in an arc shape, from the target parking position as a starting point set using the image illustrated in FIG. 6.

Note that, in the example illustrated in FIG. 8, a button B4 displayed as a GUI in the rear image 802 is a button for switching the rear image 802 to a surrounding image of another viewpoint. A specific example of the surrounding image of another viewpoint obtained by selecting (touching) the button B4 will be described later, and thus a description thereof is omitted here.

The driver moves the towing vehicle 10 backward (while turning the towing vehicle 10) while checking the overhead image 801 as illustrated in FIG. 8 so that the rear end of the towed vehicle 12 (indicator Y1) moves along the guidance path (indicator C1). Then, the parking assistance device 500 changes the screen displayed on the display device 26 to a screen as illustrated in FIG. 9 below.

FIG. 9 is an exemplary schematic view illustrating an example of a screen displayed on the display device 26 when the towing vehicle 10 moves further backward as compared with a situation illustrated in FIG. 8, in the embodiment.

Also in the example illustrated in FIG. 9, similarly to the example illustrated in FIG. 8, as the surrounding image, an overhead image 901 representing a situation around the towing vehicle 10 viewed from above, and a rear image 902 representing a situation behind the towing vehicle 10 are displayed side by side. Note that, in the example illustrated in FIG. 9, as the towing vehicle 10 and the towed vehicle 12 move further backward as compared with the situation where the screen illustrated in FIG. 8 is displayed, the indicator P10 representing the target parking position is displayed in the overhead image 901.

Here, as illustrated in FIG. 9, in the embodiment, the indicator C1 representing the guidance path extends only from one indicator P11 positioned inside of a turn of the towing vehicle 10 (indicator X1) and the towed vehicle 12 (indicator Y1) among the pair of indicators P11 and P12 constituting the indicator P10 representing the target parking position. Accordingly, it is possible to avoid the towing vehicle 10 and the towed vehicle 12 from turning excessively by driving the towing vehicle 10 while checking the indicator C1.

Note that, in the embodiment, in place of the above-described configuration in which only one guidance path extending from one target parking position corresponding to the inside of the turn is displayed, a configuration in which two guidance paths extending from a pair of target parking positions corresponding to both of the inside and an outside of the turn, respectively, are displayed may be adopted, or a configuration in which only one guidance path extending from one target parking position corresponding to the outside of the turn may be adopted.

Further, in the embodiment, the display mode (a shape, a color, or the like) of the guidance path can be variously set (changed). That is, in the embodiment, the indicator C1 indicating the guidance path can be displayed in various colors, and can be displayed in various shapes such as a two-dimensional line or a three-dimensional object.

Further, in the embodiment, a configuration in which the display mode of the guidance path is changed according to the situation may be adopted. Examples of such a configuration include a configuration in which the display mode of the guidance path is changed according to the positional relationship (for example, a degree of approach) between the towed vehicle 12 and the target parking position, and a configuration in which the display mode of the guidance path is changed according to the brightness (luminance) of the surrounding image. With the former configuration, it is possible to easily recognize the progress of parking of the towed vehicle 12 to the target parking position by observing a change in the display mode of the guidance path. Further, with the latter configuration, it is possible to improve visibility of the guidance path by displaying the guidance path brightly in a situation where the surrounding image is dark, such as at night.

Moreover, in the embodiment, a configuration, in which while the shift range of the towing vehicle 10 is set to the reverse range, the guidance path is newly calculated (obtained) each time the towing vehicle 10 is stopped and the guidance path superimposed on the surrounding image is updated each time the guidance path is newly obtained, is adopted. With this configuration, for example, when the towed vehicle 12 is moved to a position deviating from the currently displayed guidance path, an appropriate guidance path corresponding to the change in the situation can be obtained.

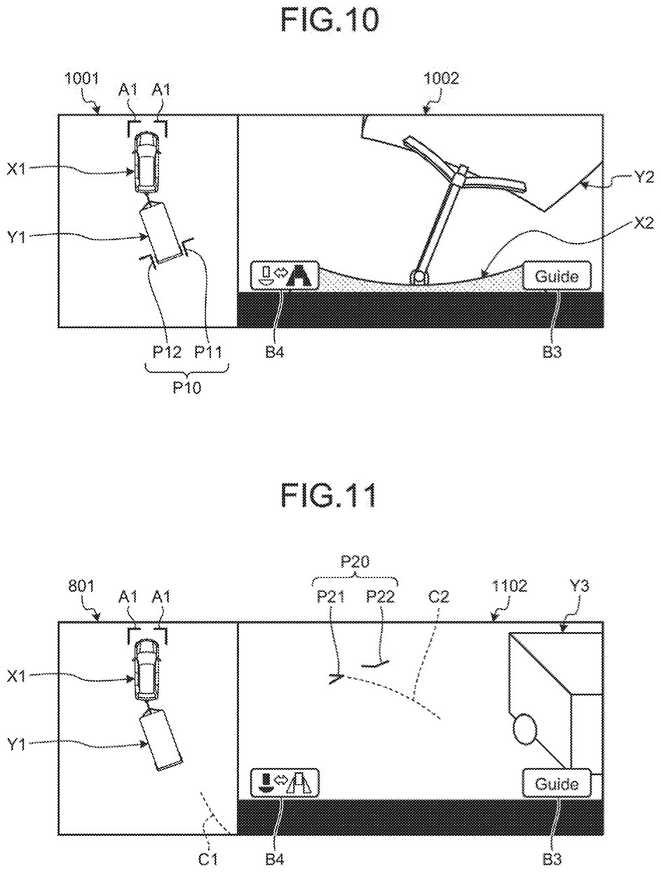

When the towing vehicle 10 (and the towed vehicle 12) moves further backward according to the image (guidance path) as illustrated in FIG. 9, the rear end of the towed vehicle 12 approaches the target parking position. Then, the parking assistance device 500 changes the screen displayed on the display device 26 to a screen as illustrated in FIG. 10 below.

FIG. 10 is an exemplary schematic view illustrating an example of a screen displayed on the display device 26 when the towing vehicle 10 moves further backward as compared with a situation illustrated in FIG. 9 and the towed vehicle 12 approaches the target parking position, in the embodiment.

Also in the example illustrated in FIG. 10, similarly to the example illustrated in FIG. 9, as the surrounding image, an overhead image 1001 representing a situation around the towing vehicle 10 viewed from above, and a rear image 1002 representing a situation behind the towing vehicle 10 are displayed side by side.

Here, in the example illustrated in FIG. 10, the indicator C1 representing the guidance path displayed before the situation where the screen illustrated in FIG. 9 is displayed is deleted from the overhead image 1001. In the embodiment, such deletion of the guidance path occurs as the towed vehicle 12 approaches the target parking position. Note that FIG. 10 illustrates a situation where the indicator Y1 is between the pair of indicators P11 and P12, that is, a situation where the towed vehicle 12 has completely reached the target parking position, but the deletion of the guidance path may be performed when the rear end of the towed vehicle 12 approaches the target parking position to some extent before the rear end of the towed vehicle 12 completely reaches the target parking position.

That is, in the embodiment, a configuration in which while the guidance path is superimposed on the surrounding image, the positional relationship (the degree of approach) between the towed vehicle 12 and the target parking position is monitored, and the guidance path superimposed on the surrounding image is deleted when the towed vehicle 12 approaches the target parking position is adopted. With this configuration, it is possible to easily recognize that the towed vehicle 12 approaches the target parking position by confirming the deletion of the guidance path.

As described above, according to the embodiment, it is possible to easily make the towed vehicle 12 to reach a desired target parking position by driving the towing vehicle 10 while checking the change of the screen displayed on the display device 26 (a change in the positional relationship between the indicator C1 representing the guidance path and the indicator Y1 representing the towed vehicle 12).

Meanwhile, in the embodiment, as described above, in the examples illustrated in FIGS. 8 to 10, when the button B4 superimposed as the GUI on each of the rear images 802, 902, and 1002 is selected (touched), each of the rear images 802, 902, and 1002 can be switched to a surrounding image of another viewpoint. Hereinafter, a screen displayed on the display device 26 in a case where the button B4 is selected (touched) in a situation where each of the screens illustrated in FIGS. 8 to 10 is displayed will be exemplified.

FIG. 11 is an exemplary schematic view illustrating an example of a screen displayed on the display device 26 when an operation of switching to a surrounding image of another viewpoint is performed in the screen illustrated in FIG. 8, in the embodiment.

In the example illustrated in FIG. 11, as the surrounding image, an overhead image 801 representing a situation around the towing vehicle 10 viewed from above similarly to that of FIG. 8, and an inside image 1102 representing a situation at the side of the towing vehicle 10 and inside of a turn are displayed side by side. The inside image 1102 can be displayed in a manner in which, for example, when the button B4 on the rear image 802 illustrated in FIG. 8 is selected (touched), the rear image 802 is switched to the inside image 1102. Conversely, when the button B4 on the inside image 1102 is selected, the inside image 1102 can be switched to the rear image 802.

Here, in the inside image 1102, an indicator Y3 represents the towed vehicle 12 viewed from the viewpoint of the inside image 1102. Further, in the inside image 1102, an indicator P20 (indicators P21 and P22) represents the target parking position viewed from the viewpoint of the inside image 1102, and an indicator C2 indicates the guidance path viewed from the viewpoint of the inside image 1102.

As described above, in the example illustrated in FIG. 11, the indicator C2 representing the guidance path is displayed not only in the overhead image 801 but also in the inside image 1102 displayed adjacent to the overhead image 801. Therefore, in the example illustrated in FIG. 11, it is possible to recognize the guidance path in a multifaceted manner by checking two types of images having different viewpoints.

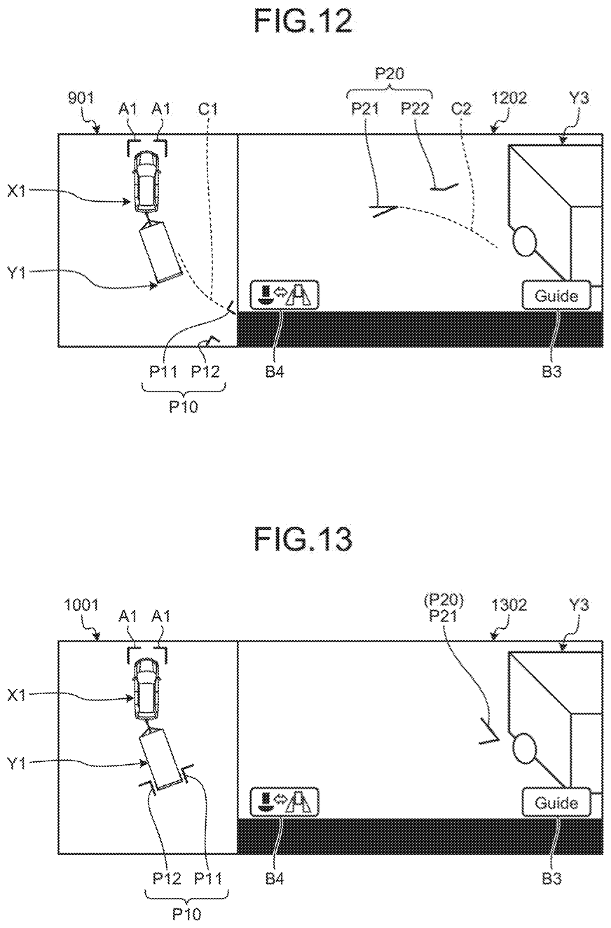

FIG. 12 is an exemplary schematic view illustrating an example of a screen displayed on the display device 26 when an operation of switching to a surrounding image of another viewpoint is performed in the screen illustrated in FIG. 9, in the embodiment.

In the example illustrated in FIG. 12, a surrounding image similar to that in the example illustrated in FIG. 11 is displayed. That is, in the example illustrated in FIG. 12, as the surrounding image, an overhead image 901 similar to that in the example illustrated in FIG. 9 and an inside image 1202 representing a situation represented by the overhead image 901 from a viewpoint of a side of the towing vehicle 10 and an inside of a turn are displayed side by side.

In the example illustrated in FIG. 12, it is possible to recognize the guidance path (indicators C1 and C2) and the target parking position (indicators P10 and P20) in a multifaceted manner by using two types of images, the overhead image 901 and the inside image 1102.

FIG. 13 is an exemplary schematic view illustrating an example of a screen displayed on the display device 26 when an operation of switching to a surrounding image of another viewpoint is performed in the screen illustrated in FIG. 10, in the embodiment.

In the example illustrated in FIG. 13, a surrounding image similar to those in the examples illustrated in FIGS. 11 and 12 is displayed. That is, also in the example illustrated in FIG. 13, as the surrounding image, the overhead image 1001 similar to that in the example illustrated in FIG. 10 and an inside image 1302 representing a situation represented by the overhead image 1001 from a viewpoint pf a side of the towing vehicle 10 and the inside of the turn are displayed side by side.

In the example illustrated in FIG. 13, since the towed vehicle 12 (indicators Y1 and Y3) has reached the target parking position (indicators P10 and P20), the previously displayed guidance path (indicators C1 and C2) is deleted from the image. Therefore, in the example illustrated in FIG. 13, it is possible to easily recognize that the towed vehicle 12 approaches the target parking position by confirming the deletion of the guidance path from the surrounding images of two types of viewpoints.

Next, processing performed in the embodiment will be described.

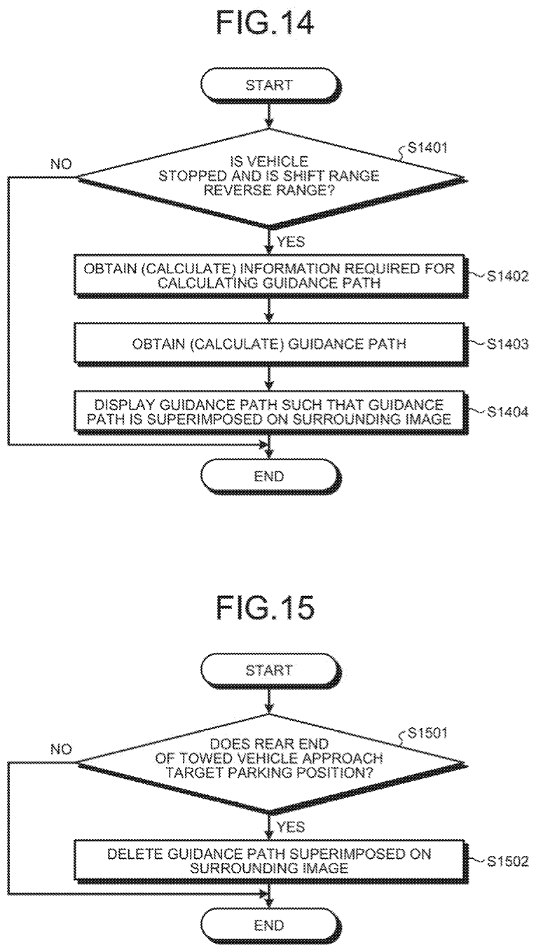

FIG. 14 is an exemplary schematic flowchart illustrating processing performed as parking assistance by the parking assistance device 500 according to the embodiment. The processing flow illustrated in FIG. 14 is performed in a case where the target parking position is set by the driver.

In the processing flow illustrated in FIG. 14, first, in S1401, the parking assistance device 500 determines whether or not an own vehicle (the towing vehicle 10) is stopped, and whether or not a shift range of the host vehicle is set to the reverse range.

In a case where at least one of the two conditions in S1401 is not satisfied, the processing ends. However, in a case where both of the two conditions in S1401 are satisfied, the processing proceeds to S1402.

In S1402, the parking assistance device 500 obtains (calculates) information required for calculating the guidance path. The information required for calculating the guidance path includes, as described above, information on the target parking position, information on positions of the towing vehicle 10 and the towed vehicle 12, information on specifications of the towing vehicle 10 and the towed vehicle 12, the connection angle between the towing vehicle 10 and the towed vehicle 12, a detection result obtained by various sensors provided in the towing vehicle 10, and the like.

Then, in S1403, the parking assistance device 500 obtains (calculates) a guidance path on the basis of the information obtained in S1402.

Then, in S1403, the parking assistance device 500 displays the guidance path calculated in S1403 on the display device 26 such that the guidance path is superimposed on a surrounding image. Then, the processing ends.

Note that the processing flow illustrated in FIG. 14 is repeatedly performed until parking of the towed vehicle 12 at the target parking position is completed. Therefore, in the embodiment, as described above, in a case where the shift range of the towing vehicle 10 is set to the reverse range, the guidance path is newly obtained each time the towing vehicle 10 is stopped and the guidance path superimposed on the surrounding image is updated each time the guidance path is newly obtained.

FIG. 15 is an exemplary schematic flowchart illustrating processing performed by the parking assistance device 500 during display of a guidance path according to the embodiment.

In the processing flow illustrated in FIG. 15, first, in S1501, the parking assistance device 500 determines whether or not the rear end of the towed vehicle 12 has approached the target parking position. A criterion for the determination is not only that the rear end of the towed vehicle 12 has completely reached the target parking position, but also that a distance between the rear end of the towed vehicle 12 and the target parking position has become a predetermined value or less.

In a case where it is determined in S1501 that the rear end of the towed vehicle 12 has not approached the target parking position, the processing ends. On the other hand, in a case where it is determined in S1501 that the rear end of the towed vehicle 12 has approached the target parking position, the processing proceeds to S1502.

Then, in S1502, the parking assistance device 500 deletes the guidance path superimposed on the surrounding image. Then, the processing ends.

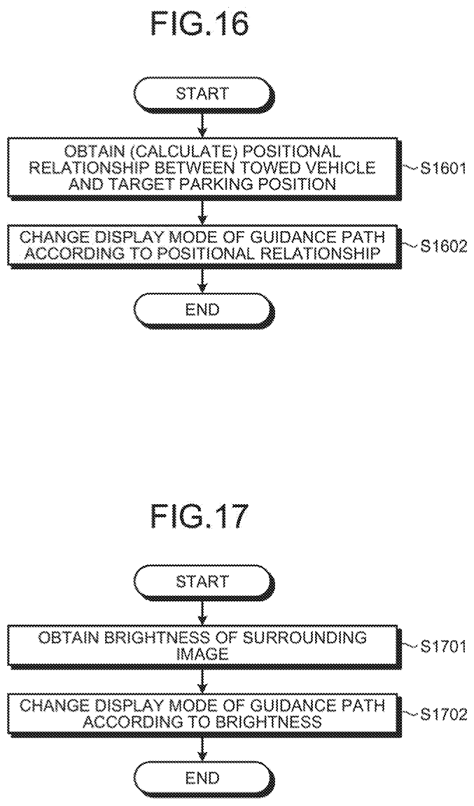

FIG. 16 is an exemplary schematic flowchart illustrating processing performed by the parking assistance device 500 according to the embodiment in a case of changing a display mode of the guidance path according to a positional relationship between the towed vehicle 12 and the target parking position.

In the processing flow illustrated in FIG. 16, first, in S1601, the parking assistance device 500 obtains (calculates) a positional relationship between the towed vehicle 12 and the target parking position. The positional relationship is, for example, a degree of approach between the towed vehicle 12 and the target parking position, which is obtained on the basis of the estimation result obtained by the target position estimation unit 509 and the trailer position estimation unit 511 described above.

Then, in S1602, the parking assistance device 500 changes a display mode (a shape, a color, or the like) of the guidance path superimposed on the surrounding image according to the positional relationship obtained in S1601. With the processing in S1602, as described above, it is possible to easily recognize the progress of parking of the towed vehicle 12 to the target parking position by observing the change in the display mode of the guidance path. Then, the processing ends.

FIG. 17 is an exemplary schematic flowchart illustrating processing performed by the parking assistance device 500 according to the embodiment in a case of changing the display mode of the guidance path according to a brightness of a surrounding image.

In the processing flow illustrated in FIG. 17, first, in S1701, the parking assistance device 500 obtains a brightness of the surrounding image. The brightness of the surrounding image corresponds to, for example, the luminance of the surrounding image.

Then, in S1702, the parking assistance device 500 changes the display mode (a shape, a color, or the like) of the guidance path according to the brightness obtained in S1701. With the processing of S1702, it is possible to easily recognize the guidance path by displaying the guidance path brightly in a situation where the surrounding image is dark, such as at night. Then, the processing ends.

As described above, the parking assistance device 500 according to the embodiment includes the image processing unit 503 that generates a surrounding image representing a situation around the towing vehicle 10 on the basis of the image capturing result obtained by the image capturing unit 24 provided in the towing vehicle 10, and the guidance path calculation unit 515 that obtains a guidance path for guiding the rear end of the towed vehicle 12 to a target parking position, the guidance path extending from the target parking position as a starting point in a case where the target parking position of the towed vehicle 12 connected to the towing vehicle 10 is set. Further, the parking assistance device 500 includes the display processing unit 517 that displays the guidance path such that the guidance path is superimposed on the surrounding image when the guidance path is obtained. With this configuration, the guidance path superimposed on the surrounding image becomes a more accurate guide particularly in the vicinity of the target parking position, as compared with, for example, the path line extending from the rear end of the towed vehicle 12 as a starting point according to the related art. Therefore, according to the embodiment, it is possible to provide a guide for more accurately guiding the rear end of the towed vehicle 12 to the target parking position.

Note that, in the above-described embodiment, an example in which the guidance path is configured to guide the rear end of the towed vehicle 12 (that is, the guidance path is calculated by considering the rear end of the towed vehicle 12 as one of references) has been described. However, the guidance path according to the embodiment only needs to be configured to guide a part of the towed vehicle 12, and is not limited to the configuration in which the guidance path guides the rear end of the towed vehicle 12. In the embodiment, for example, a guidance path configured to guide the wheels 22 of the towed vehicle 12 or a guidance path configured to guide a central axis of the wheels 22 can be used.

### Modified Example

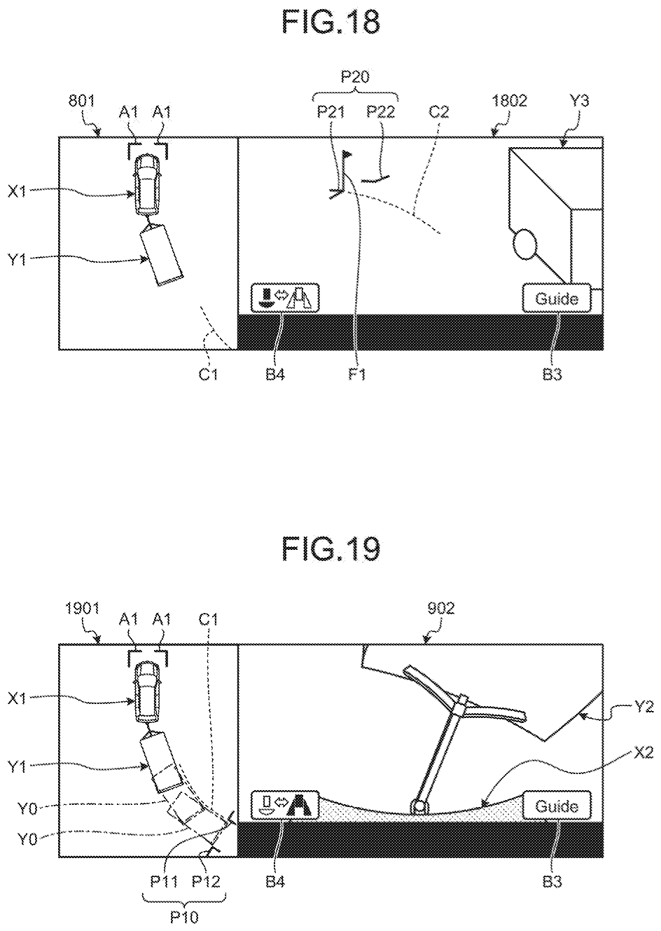

Note that, as a modified example, a configuration for improving the visibility of the target parking position as illustrated in FIG. 18 below may be added to the configuration of the above-described embodiment.

FIG. 18 is an exemplary schematic view illustrating an example of an indicator (icon or symbol) F1 for highlighting a target parking position, which can be displayed in a modified example. The indicator F1 is an example of a “first indicator”. In the example illustrated in FIG. 18, instead of the inside image 1102 illustrated in FIG. 11, an inside image 1802 including an indicator F1 such as a flag for highlighting an indicator P20 representing the target parking position is displayed. Note that a shape, a size, a color, and the like of the indicator F1 can be variously set (changed).

In the inside image 1802 illustrated in FIG. 18, among the pair of indicators P21 and P22 constituting the indicator P20 representing the target parking position, the indicator F1 is displayed at only a position corresponding to the indicator P21 positioned inside of a turn of the towed vehicle (indicator Y3). Therefore, it is possible to improve the visibility of the target parking position located inside of the turn by checking the indicator F1. Note that the indicator F1 may be displayed one by one at both of the position corresponding to the indicator P21 and a position corresponding to the indicator P22, or may be displayed only at the position corresponding to the indicator P22.

Moreover, as another modified example, a configuration for easily obtaining an image of movement of the towed vehicle until the towed vehicle reaches the target parking position as illustrated in FIG. 19 below may be added to the configuration of the above-described embodiment.

FIG. 19 is an exemplary schematic view illustrating an example of a ghost Y0 of the towed vehicle 12, which can be displayed in another modified example. The ghost Y0 is an example of a “second indicator”. In the example illustrated in FIG. 19, instead of the overhead image 901 illustrated in FIG. 9, an overhead image 1901 including the ghost Y0 which is an image representing movement of the towed vehicle 12 (indicator Y1) that is expected in a case where the towed vehicle 12 (indicator Y1) reaches the target parking position (indicator P10) along the guidance path (indicator C1) is displayed. Note that a shape, a size, a color (transmittance), and the like of the ghost Y0 can be variously set (changed).

As illustrated in FIG. 19, a plurality of ghosts Y0 are displayed along the indicator C1 representing the guidance path. Therefore, it is possible to easily obtain an image of the movement of the towed vehicle 12 until the towed vehicle 12 reaches the target parking position by checking the ghosts Y0.

Hereinabove, although the embodiment of the present invention has been described, the embodiment described above is only an example and does not intent to limit the scope of the present invention. The new embodiment described above can be implemented in various forms, and various omissions, replacements, and changes can be made without departing from the spirit of the present invention. The above-described embodiment and modifications thereof are included in the scope and gist of the present invention, and are also included in the invention described in the claims and equivalents thereof.

### EXPLANATIONS OF LETTERS OR NUMERALS

10 Towing vehicle
12 Towed vehicle
24 Image capturing unit
500 Parking assistance device
503 Image processing unit
515 Guidance path calculation unit (path obtaining unit)
517 Display processing unit

1. A parking assistance device comprising:
an image processing unit that generates a surrounding image representing a situation around a towing vehicle based on an image capturing result obtained by an image capturing unit provided in the towing vehicle;
a path obtaining unit that obtains a guidance path for guiding a towed vehicle to a target parking position, the guidance path extending from the target parking position as a starting point, when the target parking position of the towed vehicle connected to the towing vehicle is set; and
a display processing unit that displays the guidance path such that the guidance path is superimposed on the surrounding image when the guidance path is obtained.

2. The parking assistance device according to claim 1, wherein the target parking position includes a pair of target positions corresponding to a vehicle width of the towed vehicle, and
the display processing unit displays the guidance path extending from at least one target position located inside of a turn of the towing vehicle among the pair of target positions such that the guidance path is superimposed on the surrounding image.

3. The parking assistance device according to claim 1, wherein when the towed vehicle approaches the target parking position, the display processing unit deletes the guidance path superimposed on the surrounding image.

4. The parking assistance device according to claim 1, wherein the display processing unit changes a display mode of the guidance path according to a positional relationship between the towed vehicle and the target parking position.

5. The parking assistance device according to claim 1, wherein the display processing unit changes a display mode of the guidance path according to brightness of the surrounding image.

6. The parking assistance device according to claim 1, wherein the display processing unit further superimposes a first indicator for highlighting the target parking position on the surrounding image in addition to the guidance path.

7. The parking assistance device according to claim 1, wherein the display processing unit further superimposes, on the surrounding image, a second indicator representing movement of the towed vehicle expected when the towed vehicle reaches the target parking position along the guidance path.

8. The parking assistance device according to claim 1, wherein
when the towing vehicle is in a backward movement state, the path obtaining unit newly obtains the guidance path each time the towing vehicle is stopped, and
the display processing unit updates the guidance path superimposed on the surrounding image each time the guidance path is newly obtained.

9. The parking assistance device according to claim 1, wherein
the surrounding image includes an overhead image representing the situation around the towing vehicle viewed from above, and an inside image representing a situation inside of a turn of the towing vehicle, and
the display processing unit displays at least one image of the overhead image and the inside image as the surrounding image, and superimposes the guidance path on the at least one image.
